(19) United States
(12) Patent Application Publication
(10) Pub. No.: US 2010/0154894 A1
(43) Pub. Date: Jun. 24, 2010

(54) Hydraulic Unloading Valve

(75) Inventors: Edward C. Kotapish, Willow Park, TX (US); Mark D. Matzner, Burleson, TX (US)

Correspondence Address: BRACEWELL & GIULIANI LLP, P.O. BOX 61389, HOUSTON, TX, 77208-1389, US

(73) Assignee: Weir SPM, Inc., Fort Worth, TX (US)

(21) Appl. No.: 12/642,541

(22) Filed: Dec. 18, 2009

Related U.S. Application Data
(60) Provisional application No. 61/138,795, filed on Dec. 18, 2008.

(51) Int. Cl. F16K 15/02

(52) U.S. Cl. 137/14; 137/528

(57) ABSTRACT

A pressure relief system for a reciprocating pumping system that deintensifies pressure from the pumping system and controls relief operation with the deintensified pressure. The relief system includes a relief valve connected to the pumping system and a control system that selectively opens the relief valve when an overpressure is sensed in the pumping system. To keep the relief valve in a closed position, the control system maintains a backpressure on the relief valve using the deintensified pressure. A dump valve in the control system selectively vents the backpressure so the relief valve can open. A charging system can be used for charging the control system and for reseating the relief valve.

### CROSS REFERENCE TO RELATED APPLICATIONS

This application claims priority to and the benefit of co-pending U.S. Provisional Application Ser. No. 61/138,795, filed Dec. 18, 2008, the full disclosure of which is hereby incorporated by reference herein.

### FIELD OF THE INVENTION

The present invention relates in general to valves and in particular to an improved pressure relief valve that relieves a pressure of a system. The relieving set pressure is maintained by a dedicated hydraulic circuit.

### DESCRIPTION OF RELATED ART

In oil field operations, reciprocating pumps are often used for various purposes. Some reciprocating pumps, generally known as “service pumps,” typically pump service fluids used for downhole operations such as cementing, acidizing, or fracing a well. These service pumps may typically operate for relatively short periods of time, but on a frequent basis such as several times a week. Often they are mounted to a truck or a skid for transport to various well sites.

Pressure within the pump discharge circuit may unexpectedly increase, due to a line blockage, excess heating, or other reason. Pressure relief systems can be included with the discharge circuit for relieving unacceptable pressure buildup in the discharge circuit. The pressure relief system generally includes a valve having a side in fluid communication with the discharge circuit, and another side in fluid communication with a relief circuit. Opening the relief valve vents the discharge circuit to the relief thereby allowing the overpressured circuit to vent before damaged by overpressure. The relief valve can open directly in response to overpressure, one example is where a prestressed spring seats the valve until a discharge circuit reaches a set pressure. Optionally, sensors can monitor pressure, and when an unacceptable high pressure is sensed, a signal sent to a controller may actuate the valve open enabling the discharge circuit to relieve.

### SUMMARY OF THE INVENTION

Disclosed herein is an example of a method of relieving pressure from a pumping circuit that includes providing a relief valve that has a body, an axial passage in the body, a discharge port formed in the body in fluid communication with a portion of the passage, and a piston axially moveable within the passage and having a high pressure end a low pressure end on a side opposite the high pressure end. The method of, this example may further include providing fluid communication between the pumping circuit and the high pressure end of the piston, urging the piston into a closed position by maintaining a backpressure on the low pressure side of the piston so that the high pressure side of the piston seats into a closed position to block fluid communication between the pumping circuit and the discharge port, providing a selectively openable dump valve in pressure communication with the low pressure side of the piston, and opening the dump valve, when the pressure in the pumping circuit reaches a set point, by communicating to the dump valve a fraction of the pumping circuit pressure, so that the backpressure on the piston vents through the dump valve, the pumping circuit pressure unseats the piston, and fluid in the pumping circuit flows into the relief valve and out the discharge port.

Also disclosed herein is a pressure relief system for use with a pumping circuit. In one example the pressure relief system includes a relief valve, a body, an axial passage in the body, a discharge port formed in the body in fluid communication with a portion of the passage, a piston axially moveable within the passage and having a high pressure end in pressure communication with the pumping circuit and a low pressure end on a side opposite the high pressure end, and a back pressure space within the portion of the passage between the low pressure end of the piston and the body. The pressure relief system also may include a control system operating at a pressure that is a fraction of the pumping circuit operating pressure and having a selectively openable dump valve in a flow path between the back pressure space and a vent.

In yet another example, disclosed herein is a relief valve for a pumping circuit, the relief valve can include a body, an inlet port, a backpressure space in the body, a high pressure surface having a cross sectional area in pressure communication with the pumping circuit, a low pressure surface having a cross sectional area that is greater than the cross sectional area of the high pressure surface and in pressure communication with the backpressure space, a coupling between the high pressure surface and the low pressure surface, so that when the pumping circuit is operating, the backpressure space is at a pressure having a value at least the value of the pumping circuit pressure multiplied by the ratio of a quotient of the high pressure surface cross sectional area divided by the low pressure surface cross sectional area, a resultant force within the coupling urges the high pressure surface into sealing engagement with the inlet port to block flow from the pumping circuit into the relief valve.

### BRIEF DESCRIPTION OF THE DRAWINGS

Some of the features and benefits of the present disclosure having been stated, others will become apparent as the description proceeds when taken in conjunction with the accompanying drawings, in which:

FIG. 1 is a side schematic view of a subterranean fracturing system in the process of fracturing a well.

FIG. 2 is a side partial sectional view of a relieving system.

FIG. 3 is an example of a control system for use with the relieving system of FIG. 2.

FIG. 4 illustrates the control system of FIG. 3 in an alternate configuration.

FIG. 5 illustrates the control system of FIG. 4 in an alternate configuration.

While the subject device and method will be described in connection with the preferred embodiments but not limited thereto. On the contrary, it is intended to cover all alternatives, modifications, and equivalents, as may be included within the spirit and scope of the present disclosure as defined by the appended claims.

### DETAILED DESCRIPTION OF THE INVENTION

The method and system of the present disclosure will now be described more fully hereinafter with reference to the accompanying drawings in which embodiments are shown. The described method and system may be in many different forms and should not be construed as limited to the illustrated embodiments set forth herein; rather, these embodiments are provided so that this disclosure will be thorough and complete, and will fully convey its scope to those skilled in the art. Like numbers refer to like elements throughout.

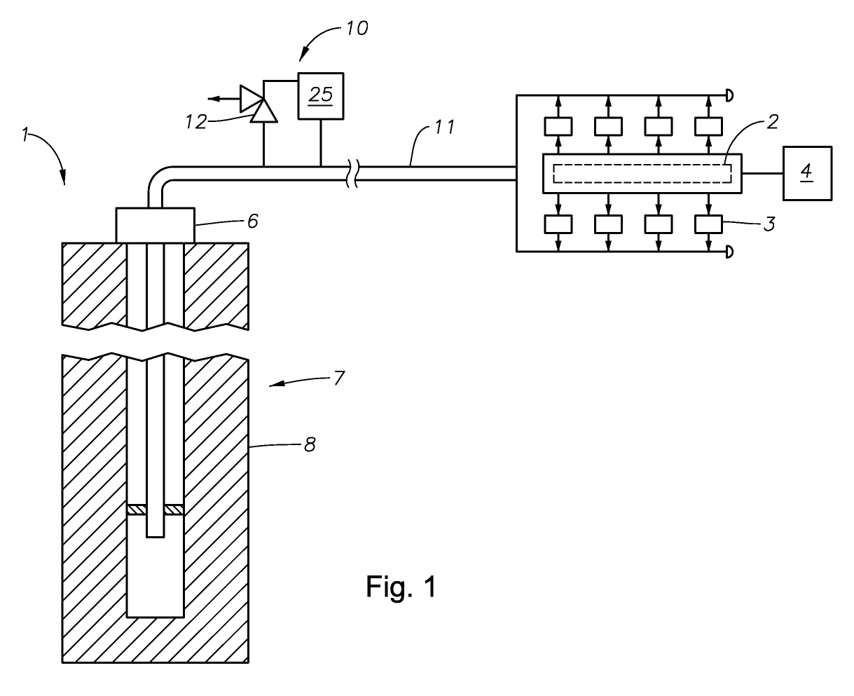

FIG. 1 is schematic partial sectional view illustrating an example of a fracing system 1 delivering high pressure fluid into a subterranean formation. Example uses of the fluid include fracturing a formation, treating the well, or cementing casing. The system 1 includes a manifold 2 connected to pumps 3 that pressurize fluid for delivery to the subterranean formation. The pumps 3 each have a suction line shown drawing a fluid from a reservoir 4. The reservoir 4 may include injection ports (not shown) for additive injection, such as a proppant, to the fluid. The pumps 3 discharge into a discharge line 11 shown extending to wellhead assembly 6. After delivering fluid to the wellhead 6, the fluid can be ported into the wellbore 7 as well as the formation 8. A pressure relief system 10 is provided on the discharge line 11 to prevent over-pressuring of the discharge line 11. In the embodiment shown, the pressure relief system 10 includes a relief valve 12 connected to the discharge line 11, and a control system 25 also connected to the discharge line 11 and to the relief valve 12. Examples of maximum operating pressure in the discharge line can include around 5,000 pounds per square inch, about 15,000 pounds per square inch, and values between. While blockage in the line 5 or within the wellbore 7 can cause over pressure, the inherent nature of the fracturing fluids and its constituents therein can also cause pressure excursions in the system 1 that can exceed a maximum desired pressure.

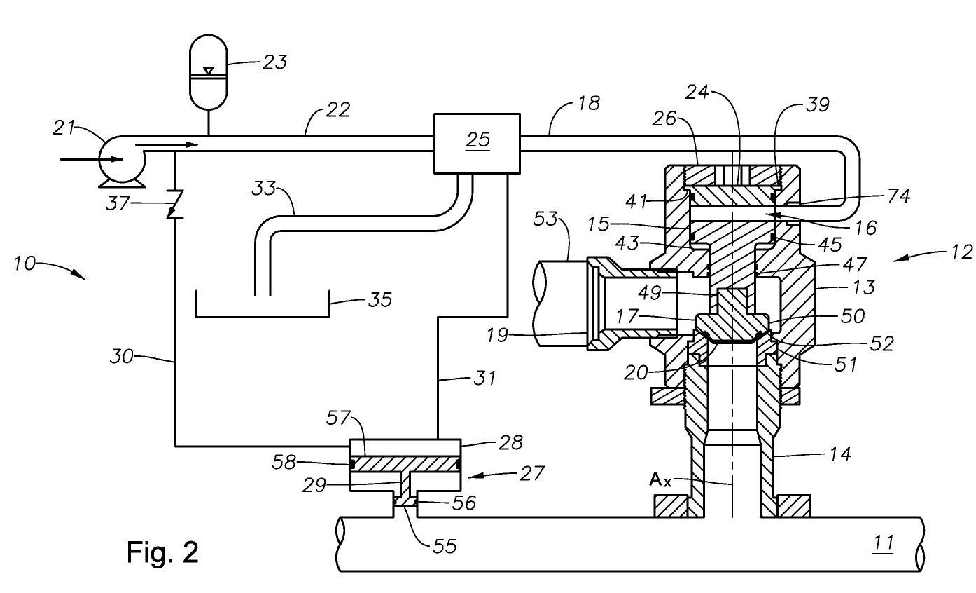

With reference now to FIG. 2, a side partial sectional schematic of a relieving system 10 for use in high pressure fluid is shown. In this embodiment, discharge line 11 is shown with an attached relief valve 12. As noted above, the discharge line 11 may include a pressurized fracturing fluid from a pump, such as from one or more of the pumps 3 in FIG. 1. The relief valve 12 illustrated includes a valve body 13 with an attached annular inlet 14. The annular inlet 14 is shown threaded within the valve body 13 on one end, and the other end of the inlet 14 is shown flangedly connected to the discharge line 11. An annular seating collar 51 is provided on the end of the inlet 14 projecting within the valve body 13. The inlet 14 is ported along an axis Aₓ of the valve 12 and in open fluid communication with the discharge line 11; thereby providing fluid communication between the valve body 13 and the discharge line 11. A passage 16 is shown formed through the valve body 13 oriented along the axis Aₓ. A disk 24 is coaxially set in the passage 16 distal from the inlet 14. A lip 39 extends radially from an end of the disk 24 and is shown resting on a shoulder 41 formed within the valve body 13 where the passage 16 extends radially outward.

A piston 15 shown provided within the passage 16 and axially moveable therein. The passage 16 radius reduces at a transition 43 shown in the valve body 13 between the disk 24 and the inlet 14. A portion of the piston 15 has a radius that is correspondingly reduced so that the reduced portion of the piston 15 is axially moveable within the passage 16 below the transition 43. A seal 45 is shown disposed on the outer circumference of the piston 15 and on its larger diameter portion. Seals 47 are also illustrated along the inner surface of the passage 16 below the transition 43. The seals 45, 47 can form a pressure barrier between the piston 15 and the passage 16 to prevent pressure communication along the length of the piston 15. An annular relief port 19 is shown threadingly attached to the valve body 13 between the inlet 14 and the shoulder 43. An open space through the relief port 19 provides communication from a portion of the passage 16 to outside of the valve body 13. The pressure barrier provided by the seals 45, 47 isolates the open space in the relief port 19 from the portion of the passage 16 above the piston 15.

A valve element 17 is shown depending from the end of the piston 15 distal from the disk 24. In the embodiment of FIG. 2, the valve element 17 includes a head portion 50 with a smaller diameter stem portion 49 projecting from the head portion 50. The valve element 17 is attached to the piston 15 by insertion of the stem portion 49 into the lower end of the piston 15. The head portion 50 is shown having a seating surface 20 on its side opposite where the stem portion 49. The side of the head portion 50 having the seating surface 20 is shown beveled along its outer periphery. In the example of FIG. 2, the valve element 17 is shown in sealing contact with the seating collar 51 and blocking fluid flow through the inlet 14 and into the valve body 13. The beveled portion of the seating surface 20 is shown sealingly mating with a correspondingly beveled surface 52 provided where the seating collar 41 opens into the valve body 13.

A control line 18 is shown in fluid communication with the portion of the passage 16 through a backpressure port 74 formed through the valve body 13 between the disk 24 and piston 15. The control line 18 further communicates to a control system 25. As will be described in further detail below, the control system 25 maintains a particular back pressure on the upper end of the piston 15 so that the valve 12 sustains a substantially precise discharge pressure. Preferably, cross sectional area of the side of the piston 15 facing the disk 24 exceeds the cross sectional area of the seating element 20. The area differential on opposing sides of the piston 15 and valve element 17 assembly produces a resultant force urging the seating element 20 against the seating collar 51; this can occur even when pressure in the discharge line 11 exceeds pressure in the portion of the passage 16 above the piston 15. The area differential thus can provide for lower pressures in the control line 18 and the control system 25, which maintaining the valve element 17 in a seated configuration. One advantage of lowering pressure requirements in the control system 25 and its associated hardware, is that smaller and less expensive control elements may be used.

In one example of use, the control system 25 maintains a pressure in the control line 18 and the portion of the passage 16 above the piston 15 of sufficient magnitude so that a resultant force is formed urging the valve element 17 into sealing engagement with the seating collar 51. In one example however, the pressure maintained by the control system 25 is maintained at a value so that if the discharge line 11 pressure exceeds a set relieving pressure, the valve element 17 will unseat. Examples of set relieving pressures include up to about 5,000 pounds per square inch (psi), up to about 7,500 psi, up to about 10,000 psi, up to about 15,000 psi, and values therebetween. When the force applied on the valve element 17 from the fluid pressure in the discharge line 11 exceeds the force applied on the piston 15 from the fluid pressure in the control line 18, the direction of the resultant force will reverse thereby sliding the valve element 17 and piston 15 will upwards away from the inlet 14. Moving the valve element 17 away from the inlet 14 unseats the seating element 20 from the seating collar 51 to open fluid communication between the inlet 14 and the relief port 19. The outlet port 19 is shown connected to an optional drain line 53, so that any relieving flow from the discharge line 11 exiting the relief port 19 may be directed to desired collection site (not shown).

A sensing unit 27 is shown attached to and in fluid communication with the discharge line 11. In one example, the sensing unit 27 is disposed proximate the relief valve 12. The sensing unit 27 as shown includes an outer housing 28 having an end in fluid communication with the discharge line 11 and another end in fluid communication with the control system 25. A differential piston 29 is illustrated within the housing 28 having a high pressure head 55 on one end and a low pressure head 57 on an opposite end. The high pressure head 55 is shown having a cross sectional area less than the cross sectional area of the low pressure head 57. The inner circumference of the housing 28 is sized to substantially match the outer profiles of both the high and low pressure heads 55, 57 and to maintain a sealing surface between the housing 28 and outer profiles of the high and low pressure heads 55, 57 with movement of the piston 29 axially within the housing 28. Seals 56, 58 are shown respectfully provided on the outer peripheries of the high and low pressure heads 55, 57.

A surface of the high pressure head 55 is shown facing and in pressure communication with the discharge line 11. An oppositely facing surface on the low pressure head 57 is in pressure communication with the control system 25 via a sensing line 31 shown connecting the housing 28 and control system 25. As noted above, the disparate cross sectional areas of the high and low pressure heads 55, 57 define an area ratio between the high and low pressure heads 55, 57. The area ratio requires the pressure in the discharge line 11 exceed the pressure on the low pressure head 57 by a factor substantially equal to the area ratio.

The control system 25 includes a discharge or drain line 33 communicating the control system 25 to a drain 35. The control system 25 may be hydraulically pressurized by a pump 21 shown having a discharges coupled with a charging line 22. The charging line 22 extends from the discharge of the pump 21 and connects to the control system 25. An accumulator 23 may optionally be included that is in pressure and/or fluid communication with the charging line 22. In one example of use, the pump 21 pressurizes a fluid that is discharged into the charging line 22 and flows to the control system 25. An example fluid pressurized by the pump 21 includes hydraulic fluid, incompressible liquids, and other liquids. The accumulator 23 is illustrated as a closed container with a space therein in which a volume of fluid can be stored. Some of the fluid being discharged into the charging line 22 may be diverted into the accumulator 23 and stored therein. A resilient member (not shown) can be disposed in the head space of the accumulator 23. The resilient member can be a compressed gas, such as air, nitrogen, helium, and the like. Alternatively, a compressible bladder, a seal with a spring, or a sealed foam member can be used as the resilient member. Thus fluid from the pump 21 that is stored in the accumulator 23 can be maintained under pressure for a period of time. A line 30 also connects to the charging line 22 shown branching to the housing 28. A check valve 37 may be provided in the line 30 to prevent backflow from the housing 28 to the charging line 22. Thus any fluid urged from the housing is diverted to the control system 25.

The pump 21 can operate until pressure in the lines 22, 30, accumulator 23, and control system 25 is at a pre-determined pressure. This value can vary depending on design parameters of devices in communication with the pump 21, but can be determined by those skilled in the art without undue experimentation. In one example of use, the pump 21 will charge the system to a pressure relating to the maximum pressure allowable in the discharge line 11 and the area ratio between the cross sectional area of the upper surface of the piston 15 and cross sectional area of the sealing element 20. Optionally, the area ratio of the high and low pressure heads 55, 57 can be correlated to the maximum allowable pressure in the discharge line 11. Alternatively, both area ratios can dictate the charging pressure of the pump 21. Once charging is complete, the pump 21 can be deactivated. Pressurizing and sealing fluid in the charging line 22, accumulator 23, and control system 25 creates a pressurized system. In the event of some leakage in the system, pressure stored in the accumulator 23 can maintain a backpressure in the lines 22, 30 and control system 25.

The pressure in the discharge line 11 can be monitored by measuring fluid pressure in line 30, line 31, or the control system 25 and multiplying the measured pressure by the area ratio of the high and lower pressure heads 55, 57. Depending upon the desired set or maximum pressure in the discharge line 11, the control system 25 is configurable to actuate the relieve valve 12 upon sensing an established pressure via the sensing line 31. In one example, when the pressure for relieving is detected in the sensing lines 30, 31 by the control system 25, the control system 25 can provide fluid communication between the pressure line 18 and discharge line 33. The discharge line 33 vents to atmosphere and thus is at ambient pressure; fluid in the portion of the passage 16 above the piston 15 is maintained at some pressure above ambient, and in some instances well above ambient. Thus fluid in passage 16 above the piston 15 will readily enter the pressure line when the control system 25 communicates the pressure line 18 to the discharge line 33. Evacuating fluid from above the piston 15 removes the force for urging the valve element 17 downward. When the downward force on the valve element 17 is removed, pressure in the discharge line 11 unseats the seating element 20 from the seating collar 51 to allow fluid communication between the inlet 14 and relief port 19. As fluid in the discharge line 11 flows through the inlet 14, past the valve element 17, and out the relief port 19, it can be routed to a designated location via the drain line 53. Directing the flow from the discharge line 11 and through the drain line 53 depressurizes the discharge line 11.

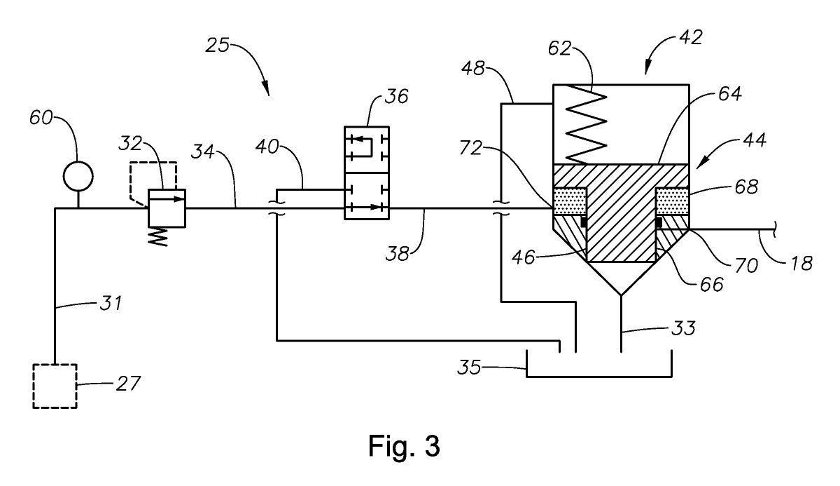

In FIG. 3, one example of a control system 25 is shown in a schematic view. In this embodiment, a sequence valve 32 is provided in line with the sensing line 31. The sequence valve 32 may be selectively adjustable to open at a pre-determined pressure at the side in fluid communication with the sensing unit 27 (shown in phantom view). A pressure indicator 60 may be used in conjunction with the sequence valve 32 to establish the opening pressure. The embodiment of the control system 25 of FIG. 3 also includes a selector valve 36. The selector valve 36 is selectively moveable between different positions that in turn selectively directs flow across the selector valve 36, then to a particular destination depending on the position of the selector valve 36. Further illustrated in the embodiment of FIG. 3, a line 34 connects between the side of the sequence valve 32 opposite the sensing unit 27 with the selector valve 36. A control line 38 is provided shown connected to an activation port 72 formed in a side of the selector valve opposite line 34 and extending into connection with a counter balance valve 42. The counter balance valve 42 illustrated in FIG. 3 includes a piston 44 that includes a flanged portion 64 with a reduced diameter body portion 66 projecting downward. The body portion 66 of the piston 44 is shown inserted into a cylinder 46. An annular space 68 is illustrated provided within the counter balance valve 42 that circumscribes the piston 44 in the space adjacent where the body portion 66 joins the flanged portion 64. A spring 62 provides a force to urge the piston 44 downward to maintain the body portion 66 within the cylinder 46. The upper surface of the piston 44 shown facing the spring 62 is in pressure communication with the drain 35 via a drain line 48. Thus the spring 62 and weight of the piston 44 are the only forces that need to be overcome to lift the piston 44.

Further illustrated in this example, the pressure line 18 connects to a return port 70 formed through a side of the counter balance valve 42; the discharge line 33 connects to a location on the lower end of the counter balance valve 42. As shown, when the reduced diameter portion of the piston 44 is inserted within the cylinder 46, fluid communication between the pressure line 18 and the discharge line 33 is blocked by the body portion 66. Thus in the embodiment of FIG. 3, the counter balance valve 42 is in a closed configuration.

For the non-limiting purpose of illustration herein, the position of the sequence valve 32 depicted in FIG. 3 is referred to as the normal operating position. When in the normal operating position, flow from the sensing unit 27 and passing through the sequence valve 32, is directed through the selector valve 36, through the control line 38, and to the counter-balance valve 42. If the fluid from the sensing unit 27 in the line 31 exceeds the pre-determined pressure selected in the sequence valve 32, the sequence valve 32 will open. When the sequence valve 32 is open, pressure and/or flow in the sensing unit 27 can communicate through the sequence valve 32 and selector valve 36 into the counter-balance valve 42 and to the annular space 68. When the force exerted onto the piston 44 from pressure in the control line 38 exceeds the weight of the piston 44 and the force applied by the spring 62, the piston 44 is moved upward thereby removing the body portion 66 from its pressure blocking position between the pressure line 18 and discharge line 33. Communicating the pressure line 18 with the discharge line 33 provides an outlet for fluid in the pressure line 18 and above the piston 15. Thus fluid within the valve body 13 above the piston 15 exits, to form a pressure imbalance across the piston 15 and allowing it to be urged upward towards the disk 24 by the higher pressure discharge fluid 11. As discussed above, this positions the relief valve 12 in a relieving configuration to allow fluid from the discharge line 11 to enter the drain line 53.

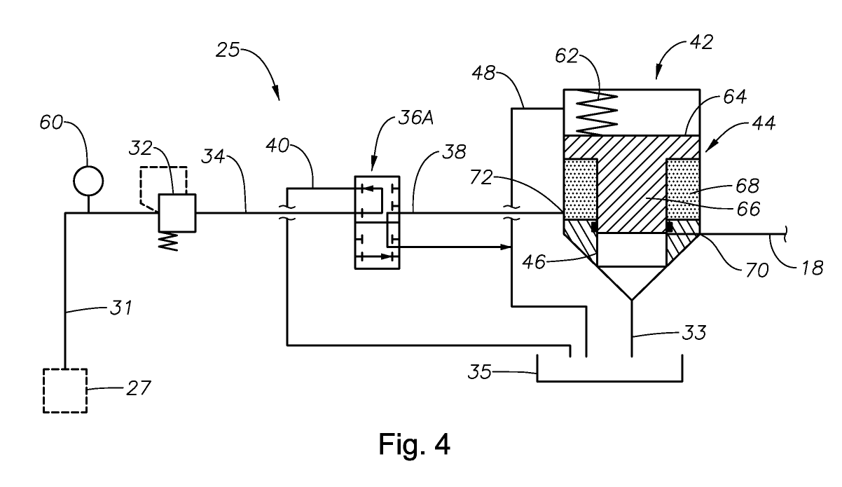

The pressure from the discharge line 11 on the differential piston 29 decreases as the discharge line 11 flow is relieved. The relief valve 12 can remain in the open position and can be reset by repositioning the piston 44 to block flow between the pressure line 18 and the discharge line 33. Shown in FIG. 4 is an example of resetting the counter balance valve 42. In this example the selector valve 36A configuration is switched so that line 34 communicates with drain line 40 through the selector valve 36A. In addition to resetting the counter balance valve 42, this configuration of the selector valve 36A could be used when recharging the control circuit 25. This diverts the flow from the sensing unit 27 that provides the force for lifting the piston 44. Optionally, fluid in the annular space 68 is directed to the drain line 48, via the selector valve 36, so the body portion 66 of the piston 44 can reinsert into the cylinder 46 and block communication between the pressure line 18 and the discharge line 33. An advantage of the presently disclosed system is the selector valve 36 can require manual actuation before the relief valve 12 can be reset into operational mode. Thus in an embodiment, the relief valve 12 does not automatically reseat. Optionally, a relief valve (not shown) can be included in the charging line 22 to prevent the pump 21 from overpressuring this line or the components in this line. Moreover, in another alternative embodiment, a bleed valve can be included in one of line 31 or line 34 for venting of excess hydraulic fluid or other fluid in the lines 31, 34.

In one example of use, the piston 15 has a 3-to-1 surface area ratio between its upper end and the valve element 17. Therefore, in situations where it is desired to have a set pressure at around 15,000 pounds per square inch, continuously maintaining pressure in the passage 16 above the piston 15 at 5,000 pounds per square inch can provide an adequate seating pressure. In one example, the side of the piston 15 and or differential piston 29 in fluid communication with the discharge line 11 is about one third that of the piston side in communication with the control system 25. Optionally, the sequence valve 32 may be adjusted so the valve 12 opens at a pressure in the discharge line 11 at or below 15,000 pounds per square inch. It is within the capabilities of those skilled in the art to determine a sequence valve 32 setting that causes the valve 12 to open at a particular pressure.

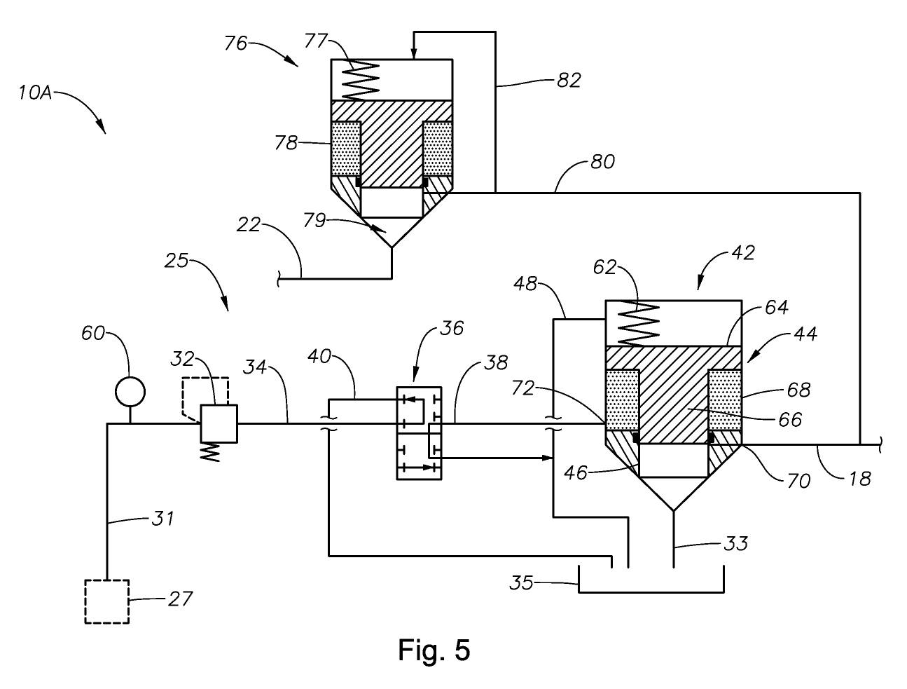

Referring now to FIG. 5, an alternate embodiment of a pressure relieving system 10A is illustrated in a side schematic view. Further included in this embodiment is a flow control valve 76 shown having a port connected to the charging line 22 and to a control line 80. The control line 80 is illustrated branching from pressure line 18, and thus is in fluid and pressure communication with the space 16. A piston 78 is shown provided within the flow control valve 76 that is selectively moved axially within the flow control valve 76 for blocking/enabling fluid communication between the charging line 22 and the control line 80. In the example of FIG. 5, the piston 78 is moved upward and out of the flow path 79 between the charging line 22 and the control line 80, thus allowing fluid from the charging line 22 to flow through the flow control valve 76, the control line 80, and space 16. A backpressure line 82 represents pressure communication from the control line 80 to above the piston 78 for maintaining the piston 78 in a closed position. When the pressure line 18 is pressurized and not being vented to the discharge line 33, the pressure on the piston 78 applied through backpressure line 82 urges the piston 78 into a closed position. However, after the pressure and/or fluid in the pressure line 18 is evacuated, and fluid flow from the pump 21 and charging line 22 is applied to the flow control valve 76, the piston 78 can be urged upward to open the valve and allow flow therethrough. Pressure drops through the flow control valve 76 and disparate cross sectional areas above and below the piston 78 results in a resultant upward force on the piston 78 when fluid flows from the charging line 22 to the control line 80. An optional spring 77 is shown above the piston 78 for providing a downward urging force onto the piston 78 which can be used to close the flow control valve 76, such as when no flow and/or pressure is applied to the flow control valve 76.

While the invention has been shown in only one of its forms, it should be apparent to those skilled in the art that it is not so limited, but is susceptible to various changes without departing from the scope of the invention.

What is claimed is:

1. A method of relieving pressure from a pumping circuit comprising:
providing a relief valve comprising:
a body,
an axial passage in the body,
a discharge port formed in the body in fluid communication with a portion of the passage, and
a piston axially moveable within the passage and having a high pressure end a low pressure end on a side opposite the high pressure end; and
providing fluid communication between the pumping circuit and the high pressure end of the piston;
urging the piston into a closed position by maintaining a backpressure on the low pressure side of the piston so that the high pressure side of the piston seats into a closed position to block fluid communication between the pumping circuit and the discharge port;
providing a selectively openable dump valve in pressure communication with the low pressure side of the piston; and
opening the dump valve, when the pressure in the pumping circuit reaches a set point, by communicating to the dump valve a fraction of the pumping circuit pressure, so that the backpressure on the piston vents through the dump valve, the pumping circuit pressure unseats the piston, and fluid in the pumping circuit flows into the relief valve and out the discharge port.

2. The method of claim 1, wherein communicating a fraction of the pumping circuit pressure comprises communicating pressure from the pumping circuit to a high pressure surface that produces a resulting force, transferring the resulting force to a low pressure surface having a cross sectional area greater than the cross sectional area of the high pressure surface, and communicating the low pressure surface with a circuit fluid thereby creating a fraction of the pumping circuit pressure in the circuit fluid.

3. The method of claim 2, wherein the ratio between the fraction of the pumping circuit pressure and the pumping circuit pressure is substantially the same as the ratio of the cross sectional area of the high pressure surface and the cross sectional area of the low pressure surface.

4. The method of claim 1, wherein the ratio of the respective cross sectional areas of the high pressure end of the piston and low pressure end of the piston is substantially the same as the ratio of the cross sectional area of the high pressure end and the cross sectional area of the low pressure end.

5. The method of claim 1, further comprising closing the dump valve by isolating the dump valve from pressure communication with the fraction of the pumping circuit pressure.

6. The method of claim 1, wherein the fraction of the pumping circuit pressure is communicated from the pumping circuit to the dump valve through a hydraulic circuit.

7. The method of claim 1, further comprising closing the dump valve and restoring a backpressure on the low pressure side of the piston so that the high pressure side of the piston reseats into a closed position to block fluid communication between the pumping circuit and the discharge port.

8. A pressure relief system for use with a pumping circuit comprising:
a relief valve comprising:
a body,
an axial passage in the body,
a discharge port formed in the body in fluid communication with a portion of the passage,
a piston axially moveable within the passage and having a high pressure end in pressure communication with the pumping circuit and a low pressure end on a side opposite the high pressure end, and
a back pressure space within the portion of the passage between the low pressure end of the piston and the body; and
a control system operating at a pressure that is a fraction of the pumping circuit operating pressure and having a selectively openable dump valve in a flow path between the back pressure space and a vent.

9. The pressure relief system of claim 8, wherein the dump valve comprises a discharge to the vent, a return port in fluid communication with the low pressure end of the piston, an activation port in selective pressure communication with a fraction of the pumping circuit pressure, so that when the dump valve is in pressure communication with a fraction of the pumping circuit pressure, the dump valve moves from a blocking position with the low pressure end of the piston isolated from the low pressure discharge into an open position with the lower pressure end of the piston in fluid communication with the low pressure discharge.

10. The pressure relief system of claim 8, wherein the control system further comprises a pressure regulator having an outlet in selective pressure communication with the dump valve, and having an inlet that is in pressure communication with the fraction of the pumping circuit pressure, so that when the pumping circuit pressure reaches a set point, the pressure regulator is changeable from a closed position with the inlet isolated from the outlet, to an open position, with the inlet and outlet in pressure communication.

11. The pressure relief system of claim 8, further comprising a sensing unit having a port in pressure communication with the pumping circuit and a reduced pressure port having a pressure that is at the fraction of the pumping circuit and in pressure communication with the control system.

12. The pressure relief system of claim 11, the sensing unit having a housing, a piston in the housing, a high pressure surface on an end of the piston in pressure communication with the pumping circuit, a reduced pressure surface on an end of the piston in pressure communication with the reduced pressure port.

13. The pressure relief system of claim 8, further comprising a hydraulic charging system comprising a pump, a circuit in fluid communication with the pump, the sensing unit, and the control system, so that when the pump is operated, fluid is introduced into the circuit and control system that can communicate the fraction of the pumping circuit pressure to the dump valve.

14. The pressure relief system of claim 8, further comprising a hydraulic charging system in fluid communication with the control system and the control system further comprising a selector valve having a relieving configuration in which the dump valve is in pressure communication with the fraction of pumping circuit pressure and a recharging configuration in which the dump valve is isolated from pressure communication with the fraction of pumping circuit pressure.

15. The pressure relief system of claim 8, further comprising a flow control check valve having an inlet port in fluid communication with a hydraulic charging system having fluid and an outlet port in fluid communication with the back pressure space, so that when the flow control check valve is opened, fluid in the hydraulic charging system is directed to the back pressure space and reseats the high pressure end of the piston to block flow from the pumping circuit into the relief valve.

16. A relief valve for a pumping circuit comprising:
a body,
an inlet port
a backpressure space in the body;
a high pressure surface having a cross sectional area in pressure communication with the pumping circuit;
a low pressure surface having a cross sectional area that is greater than the cross sectional area of the high pressure surface and in pressure communication with the backpressure space;
a coupling between the high pressure surface and the low pressure surface, so that when the pumping circuit is operating, the backpressure space is at a pressure having a value at least the value of the pumping circuit pressure multiplied by the ratio of a quotient of the high pressure surface cross sectional area divided by the low pressure surface cross sectional area, a resultant force within the coupling urges the high pressure surface into sealing engagement with the inlet port to block flow from the pumping circuit into the relief valve.

17. The relief valve of claim 16, further comprising a backpressure port formed through body and in fluid communication with the backpressure space and adapted for connection to a control system that is in pressure communication with a fraction of the pumping circuit pressure that is substantially the same as the pressure in the backpressure space.

18. The relief valve of claim 17, wherein the control system is in pressure communication with a sensing unit that comprises a port in pressure communication with the pumping circuit and a reduced pressure port having a pressure that is at the fraction of the pumping circuit and in pressure communication with the control system, a housing, a piston in the housing, a high pressure surface on an end of the piston in pressure communication with the pumping circuit, and a reduced pressure surface on an end of the piston in pressure communication with the reduced pressure port.
